(19) United States
(12) Patent Application Publication
(10) Pub. No.: US 2025/0292476 A1
(43) Pub. Date: Sep. 18, 2025

(54) ANIMATION RENDERING METHOD AND APPARATUS, AND DEVICE AND STORAGE MEDIUM

(71) Applicant: Beijing Zitiao Network Technology Co., Ltd., Haidian District, Beijing (CN)

(72) Inventors: Yang LI, Beijing (CN); Xiaopeng YAO, Beijing (CN); Baideng TIAN, Beijing (CN); Bo LI, Beijing (CN)

(21) Appl. No.: 18/861,509

(22) PCT Filed: Jul. 6, 2023
(86) PCT No.: PCT/CN2023/106047

§ 371 Date: Oct. 29, 2024

(30) Foreign Application Priority Data
Jul. 6, 2022 (CN) 202210797333.6

(51) Int. Cl. G06T 13/80; G06T 7/246

(52) U.S. Cl. CPC G06T 13/80; G06T 7/248; G06T 2213/12

(57) ABSTRACT

Provided in the present disclosure are an animation rendering method and apparatus, and a device and a storage medium. The method includes: firstly, determining a target graphic object on an image frame to be rendered in a target graphic animation and a graphic drawing mode of the target graphic object; if it is determined that the graphic drawing mode of the target graphic object is a filling drawing mode, for a triangulation state of the target graphic object, determining whether the image frame to be rendered changes compared with an adjacent previous image frame; and if the image frame to be rendered does not change, on the basis of triangulation data of a graphic object, corresponding to the target graphic object, on the adjacent previous image frame, rendering the target graphic object on the image frame to be rendered.

### CROSS-REFERENCE TO RELATED APPLICATIONS

This application is a U.S. National Stage under 35 U.S.C. § 371 of International Application No. PCT/CN2023/106047, as filed on Jul. 6, 2023, which claims the priority to the Chinese Patent Application No. 202210797333.6 entitled “ANIMATION RENDERING METHOD AND APPARATUS, AND DEVICE AND STORAGE MEDIUM” and filed on Jul. 6, 2022. The disclosure of each of these applications is incorporated by reference herein in its entirety.

### TECHNICAL FIELD

The present disclosure relates to the field of data processing, and in particular, to an animation rendering method, apparatus and device, and a storage medium.

### BACKGROUND

Lottie is a cross-platform animation scheme, that can export and generate a JSON file by a Bodymovin plugin parsing AE (Adobe After Effects, dynamic graphics software), and can realize animation effects at IOS, Android, Web and React Native ends.

However, the Web end only provides Canvas, SVG, and HTML rendering, so that when developers use rendering engines such as ThreeJS, PixiJS, and the like, only indirect rendering can be made based on creation of off-screen Canvas, resulting in poor rendering performance.

### SUMMARY

In a first aspect, the present disclosure provides an animation rendering method, comprising:
determining a target graphic object on an image frame to be rendered in a target graphic animation and a graphic drawing mode of the target graphic object;
in response to determining that the graphic drawing mode of the target graphic object is a fill drawing mode, determining whether the image frame to be rendered changes compared with an adjacent previous image frame with respect to a triangulation state of the target graphic object; wherein the adjacent previous image frame is a previous frame adjacent to the image frame to be rendered in the target graphic animation; and
in response to determining that the image frame to be rendered does not change compared with the adjacent previous image frame with respect to the triangulation state of the target graphic object, rendering the target graphic object on the image frame to be rendered based on triangulation data of a graphic object corresponding to the target graphic object on the adjacent previous image frame.

In an optional implementation, the determining whether the image frame to be rendered changes compared with an adjacent previous image frame with respect to a triangulation state of the target graphic object, comprises:
determining whether the image frame to be rendered changes compared with the adjacent previous image frame with respect to a number of vertexes of the target graphic object; and/or
determining whether the image frame to be rendered changes compared with the adjacent previous image frame with respect to a left/right state of an ear-tip vertex of the target graphic object, wherein the left/right state of the ear-tip vertex indicates whether a successor vector of the ear-tip vertex is on a left or right side of a precursor vector of the ear-tip vertex.

In an optional implementation, the determining whether the image frame to be rendered changes compared with the adjacent previous image frame with respect to a left/right state of an ear-tip vertex of the target graphic object, comprises:
in response to determining that the image frame to be rendered does not change compared with the adjacent previous image frame with respect to the number of vertexes of the target graphic object, performing the step of determining whether the image frame to be rendered changes compared with the adjacent previous image frame with respect to a left/right state of an ear-tip vertex of the target graphic object.

In an optional implementation, the determining whether the image frame to be rendered changes compared with the adjacent previous image frame with respect to a number of vertexes of the target graphic object, comprises:
determining a drawing command for the target graphic object on the image frame to be rendered and a drawing command for the corresponding graphic object on the adjacent previous image frame as a first drawing command and a second drawing command, respectively;
extracting a feature of the first drawing command and a feature of the second drawing command, respectively, according to a preset rule; and
determining whether the image frame to be rendered changes compared with the adjacent previous image frame based on a comparison result of the feature of the first drawing command and the feature of the second drawing command.

In an optional implementation, the determining whether the image frame to be rendered changes compared with the adjacent previous image frame with respect to a left/right state of an ear-tip vertex of the target graphic object, comprises:
determining the ear-tip vertex of the target graphic object based on the triangulation data of the adjacent previous image frame;
calculating a cross product of the precursor vector and the successor vector of the ear-tip vertex; and
determining whether the image frame to be rendered changes compared with the adjacent previous image frame based on a comparison result of the cross product corresponding to the ear-tip vertex and a cross product corresponding to a corresponding ear-tip vertex of the adjacent previous image frame.

In an optional implementation, the method further comprises:
in response to determining that the graphic drawing mode of the target graphic object is a stroke drawing mode, performing triangulation processing on the target graphic object based on the triangulation data of the adjacent previous image frame of the image frame to be rendered, to obtain triangulation data corresponding to the target graphic object; and
rendering the target graphic object on the image frame to be rendered based on the triangulation data of the target graphic object.

In an optional implementation, the performing triangulation processing on the target graphic object based on the triangulation data of the adjacent previous image frame of the image frame to be rendered, to obtain triangulation data corresponding to the target graphic object, comprises:
determining repeated drawing data of drawing data of the target graphic object as compared with the adjacent previous image frame;
performing triangulation processing on a graphic part corresponding to drawing data except the repeated drawing data in the drawing data of the target graphic object, to obtain newly added triangulation data; and
determining the triangulation data corresponding to the repeated drawing data and the newly added triangulation data as the triangulation data corresponding to the target graphic object on the image frame to be rendered.

In a second aspect, the present disclosure provides an animation rendering apparatus, comprising:
a first determining module, configured to determine a target graphic object on an image frame to be rendered in a target graphic animation and a graphic drawing mode of the target graphic object;
a second determining module, configured to, in response to determining that the graphic drawing mode of the target graphic object is a fill drawing mode, determine whether the image frame to be rendered changes compared with an adjacent previous image frame with respect to a triangulation state of the target graphic object; wherein the adjacent previous image frame is a previous frame adjacent to the image frame to be rendered in the target graphic animation; and
a first rendering module, configured to, in response to determining that the image frame to be rendered does not change compared with the adjacent previous image frame with respect to the triangulation state of the target graphic object, render the target graphic object on the image frame to be rendered based on triangulation data of a graphic object corresponding to the target graphic object on the adjacent previous image frame.

In a third aspect, the present disclosure provides a non-transitory computer-readable storage medium having stored thereon instructions which, when executed on a terminal device, cause the terminal device to implement the above-described methods.

In a fourth aspect, the present disclosure provides an animation rendering device comprising: a memory, a processor, and a computer program stored on the memory and executable on the processor, wherein the processor, when executing the computer program, implements the above-described methods.

In a fifth aspect, the present disclosure provides a computer program product comprising a computer program/instructions which, when executed by a processor, implement(s) the above-described methods.

In a sixth aspect, the present disclosure provides a computer program which, when executed by a processor, causes the processor to implement the above-described methods.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

In order to more clearly illustrate the embodiments of the present disclosure or technical solutions in the related art, the drawings used in the description of the embodiments or the related art will be briefly described below, and it is apparent for those skilled in the art that other drawings may be obtained according to these drawings without creative labor.

FIG. 1 is a flowchart of an animation rendering method provided by an embodiment of the present disclosure;

FIG. 2 is a schematic diagram of a graphic object provided by an embodiment of the present disclosure;

FIG. 3 is a schematic diagram of another graphic object provided by an embodiment of the present disclosure;

FIG. 4 is a schematic diagram of a polygon provided by an embodiment of the present disclosure;

FIG. 5 is a schematic diagram of yet another graphic object provided by an embodiment of the present disclosure;

FIG. 6 is a schematic diagram of stroke drawing provided by an embodiment of the present disclosure;

FIG. 7 is a schematic diagram of another stroke drawing provided by an embodiment of the present disclosure;

FIG. 8 is a schematic structural diagram of an animation rendering apparatus provided by an embodiment of the present disclosure;

FIG. 9 is a schematic structural diagram of an animation rendering device provided by an embodiment of the present disclosure.

### DETAILED DESCRIPTION

In order that the above objects, features and advantages of the present disclosure may be more clearly understood, solutions of the present disclosure will be further described below. It should be noted that, without conflict, the embodiments of the present disclosure and features in the embodiments may be combined with each other.

In the following description, numerous specific details are set forth in order to provide a thorough understanding of the present disclosure, but the present disclosure may be practiced otherwise than as described herein; it is apparent that the embodiments disclosed in the specification are only a few embodiments of the present disclosure, and not all embodiments.

The present disclosure provides an animation rendering method, comprising: firstly, determining a target graphic object on an image frame to be rendered in a target graphic animation and a graphic drawing mode of the target graphic object; in response to determining that the graphic drawing mode of the target graphic object is a fill drawing mode, determining whether the image frame to be rendered changes compared with an adjacent previous image frame with respect to a triangulation state of the target graphic object, wherein the adjacent previous image frame is a previous frame adjacent to the image frame to be rendered in the target graphic animation; then, in response to determining that the image frame to be rendered does not change compared with the adjacent previous image frame with respect to the triangulation state of the target graphic object, rendering the target graphic object on the image frame to be rendered based on triangulation data of a graphic object corresponding to the target graphic object on the adjacent previous image frame.

As can be seen, in the embodiments of the present application, by comparing the triangulation state of the target graphic object of the image frame to be rendered with that of the adjacent previous image frame, the target graphic object is rendered based on the triangulation data of the target graphic object in the adjacent previous image frame, thus repeated triangulation for the target graphic object is avoided, and the rendering performance is improved.

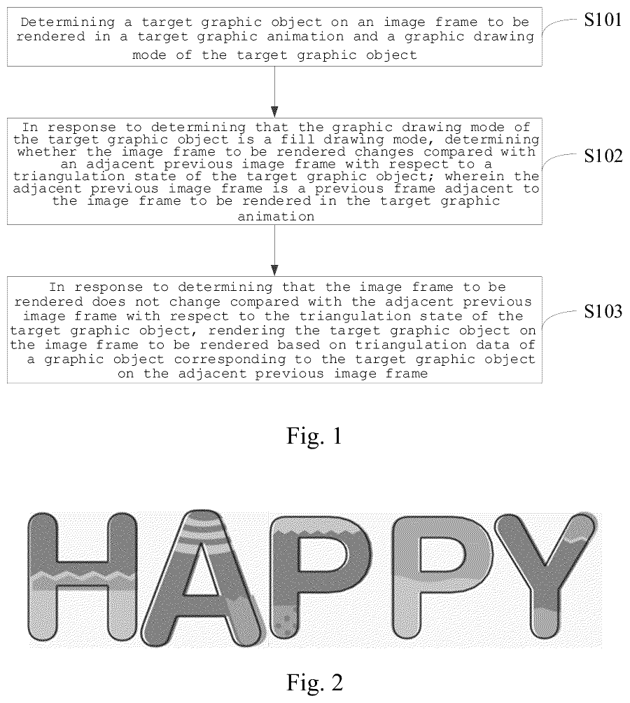

Based on this, an embodiment of the present disclosure provides an animation rendering method; with reference to FIG. 1, it is a flowchart of an animation rendering method provided by an embodiment of the present disclosure, which comprises:
S101: determining a target graphic object on an image frame to be rendered in a target graphic animation and a graphic drawing mode of the target graphic object.

The target graphic animation can be any graphic animation with continuous frames, each frame of the animation with continuous frames comprises at least one graphic object, and the same graphic object has similarity among respective frames of the graphic animation.

The image frame to be rendered may be any frame of the graphic animation with continuous frames.

The graphic object refers to an element on an image drawn based on a graphic drawing mode, and as shown in FIG. 2, each letter in “HAPPY” can be drawn based on a graphic drawing mode and thus belongs to a graphic object.

The target graphic object may be any one of graphic objects on an image frame to be rendered in a target graphic animation.

The graphic drawing mode refers to a graphic drawing method, such as a fill drawing mode, a stroke drawing mode, and the like.

Specifically, the fill drawing mode is to fill the graphic object, e.g., filling the graphic object with different colors; and the stroke drawing mode is to fill an outline of the graphic object, e.g., filling the outline of the graphic object with different shading.

In an optional implementation, the graphic drawing mode of the target graphic object may be determined according to a drawing instruction, and specifically, after the target graphic object on the image frame to be rendered is determined, the graphic drawing mode of the target graphic object is determined according to the drawing instruction.
S102: in response to determining that the graphic drawing mode of the target graphic object is a fill drawing mode, determining whether the image frame to be rendered changes compared with an adjacent previous image frame with respect to a triangulation state of the target graphic object.

The adjacent previous image frame is a previous frame adjacent to the image frame to be rendered in the target graphic animation.

The triangulation state is used for reflecting whether triangulation data changes or not, that is, the triangulation state can reflect whether the triangulation data changes or not, and the triangulation data may be data obtained after performing triangulation processing on a graph object.

The triangulation refers to segmenting a graphic object into a plurality of triangles, and it should be noted that the triangulation method is not limited in any way in the present disclosure. The triangulation state may represent a way in which the graphic object is segmented into triangles.

The triangulation state includes a number of vertexes and/or a left/right state of an ear-tip vertex of the target graphic object, that is, the number of vertexes and/or the left/right state of the ear-tip vertex of the target graphic object can be used to reflect whether the triangulation data changes.

Specifically, the number of vertexes of the target graphic object refers to the number of all vertexes constituting the target graphic object; and, the ear-tip vertex refers to a vertex corresponding to a convex corner in the target graphic object on the image frame to be rendered, and a triangle formed based on the convex corner does not contain other vertexes corresponding to the convex corner.

In an optional implementation, if the triangulation state includes the number of vertexes and the left/right state of the ear-tip vertex of the target graphic object, it is determined based on a drawing command, whether the number of vertexes of the target graphic object of the image frame to be rendered changes compared with the number of vertexes of the target graphic object of the adjacent previous image frame, and if the number of vertexes of the target graphic object of the image frame to be rendered is different from the number of vertexes of the target graphic object of the adjacent previous image frame, it indicates that the triangulation state of the target graphic object of the image frame to be rendered changes compared with that of the target graphic object of the adjacent previous image frame.

In the embodiment of the present disclosure, if the number of vertexes of the target graphic object of the image frame to be rendered is different from the number of vertexes of the target graphic object on the adjacent previous image frame, it indicates that the triangulation state of the target graphic object of the image frame to be rendered changes compared with that of the target graphic object on the adjacent previous image frame, that is, the triangulation data of the target graphic object on the adjacent previous image frame cannot be continuously reused.

If it is determined that the number of vertexes of the target graphic object of the image frame to be rendered does not change compared with the number of vertexes of the target graphic object on the adjacent previous image frame, it is determined whether a left/right state of each ear-tip vertex of the target graphic object of the image frame to be rendered changes compared with the left/right state of each ear-tip vertex of the target graphic object on the adjacent previous image frame. In response to determining that the left/right state of each ear-tip vertex of the target graphic object of the image frame to be rendered does not change compared with the left/right state of each ear-tip vertex of the target graphic object on the adjacent previous image frame, it is determined that the image frame to be rendered does not change compared with the adjacent previous image frame, otherwise, it is determined that the image frame to be rendered changes compared with the adjacent previous image frame.

In the embodiment of the present disclosure, assuming that the number of vertexes of the target graphic object of the image frame to be rendered is A, and the number of vertexes of the target graphic object on the adjacent previous image frame is B, if A=B, it indicates that the number of vertexes of the target graphic object of the image frame to be rendered does not change compared with the number of vertexes of the target graphic object on the adjacent previous image frame, then it is continuously determined whether the left/right state of each ear-tip vertex of the target graphic object of the image frame to be rendered changes compared with the left/right state of each ear-tip vertex of the target graphic object on the adjacent previous image frame, if it is determined that the left/right state of each ear-tip vertex of the target graphic object of the image frame to be rendered does not change compared with the left/right state of each ear-tip vertex of the target graphic object on the adjacent previous image frame, it is determined that the image frame to be rendered does not change compared with the adjacent previous image frame, and the triangulation data of the target graphic object on the adjacent previous image frame can be continuously reused; otherwise, the image frame to be rendered changes compared with the adjacent previous image frame, and the triangulation data of the target graphic object on the adjacent previous image frame cannot be continuously reused.

In another optional implementation, all vertexes of the target graphic object of the image frame to be rendered may also be traversed, to determine whether the number of vertexes changes compared with the number of vertexes of the target graphic object on the adjacent previous image frame, and after it is determined that the number of vertexes of the target graphic object of the image frame to be rendered does not change, it is determined whether the left/right state of the ear-tip vertex(s) of the target graphic object of the image frame to be rendered changes compared with the left/right state of the ear-tip vertex(s) of the target graphic object on the adjacent previous image frame, according to the left/right state of the ear-tip vertex(s) of the target graphic object of the image frame to be rendered, thereby determining whether the image frame to be rendered changes compared with the adjacent previous image frame.

It should be noted that, reference can be made to the following description for the calculations of the number of vertexes and the left/right state of the ear-tip vertex of the target graphic object, and the details are not repeated herein.

In yet another optional implementation, if the triangulation state only includes the number of vertexes of the target graphic object, it is determined based on a drawing command, whether the number of vertexes of the target graphic object of the image frame to be rendered changes compared with the number of vertexes of the target graphic object on the adjacent previous image frame, thereby determining whether the image frame to be rendered changes compared with the adjacent previous image frame.

If the number of the vertexes of the target graphic object of the image frame to be rendered is different from that of the target graphic object on the adjacent previous image frame, it indicates that the image frame to be rendered changes compared with the adjacent previous image frame; and, if the number of the vertexes of the target graphic object of the image frame to be rendered is the same as that of the target graphic object on the adjacent previous image frame, it indicates that the image frame to be rendered does not change compared with the adjacent previous image frame.

Specifically, a drawing command for the target graphic object on the image frame to be rendered and a drawing command on the adjacent previous image frame are respectively determined as a first drawing command and a second drawing command, a feature of the first drawing command and a feature of the second drawing command are respectively extracted according to a preset rule, and it is determined whether the image frame to be rendered changes compared with the adjacent previous image frame based on a comparison result of the feature of the first drawing command and the feature of the second drawing command.

The drawing command may be composed of a plurality of commands, such as move To, line To, and the like.

The first drawing command is a drawing command for the target graphic object on the image frame to be rendered.

The second drawing command is a drawing command for the target graphic object on the adjacent previous image frame.

The preset rule is a preset feature extraction rule, and may be set as needed; and, for example, the preset rule may be set to extract the first letter of each of drawing commands corresponding to the target graphic object on the image frame, and combine the first letters, according to a drawing order, into a feature of the drawing command corresponding to the target graphic object on the image frame. The present disclosure does not set any limit to the setting manner of the preset rule.

The feature of the drawing command may be a shorthand of the drawing command, e.g., by having the first letter of the drawing command as the feature of the drawing command. As indicated by the codes of the drawing command described below, the feature of the drawing command corresponding thereto is mlll.

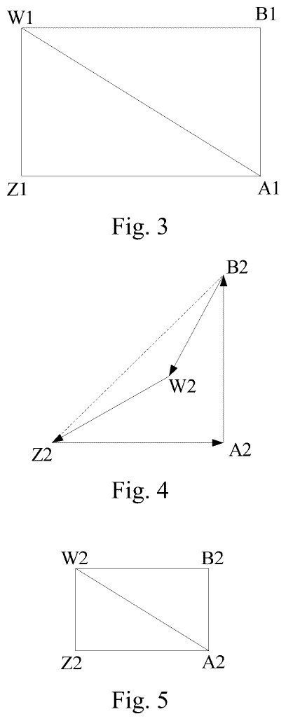

For more clearly understanding the embodiment of the present disclosure, referring to FIG. 3, which is a schematic diagram of another graphic object provided by the embodiment of the present disclosure, it is assumed that the target graphic object on the adjacent previous image frame of the target graphic object of the image frame to be rendered is a rectangle as shown in FIG. 3, wherein W1, B1, A1, and Z1 correspond to four vertexes of the rectangle respectively, and coordinates of the four vertexes are (W1.x, W1.y), (B1.x, B1.y), (A1.x, A1.y), (Z1.x, Z1.y), respectively.

The corresponding drawing command is shown as the following codes:
moveTo (W1.x, W1.y);// m
lineTo (B1.x, B1.y);//1
lineTo (A1.x, A1.y);//1
lineTo (Z1.x, Z1.y);//1

As can be seen, the feature of the second drawing command corresponding to the target graphic object on the adjacent previous image frame of the target graphic object of the image frame to be rendered is mlll, and if the feature of the first drawing command corresponding to the target graphic object of the image frame to be rendered is the same as the second drawing command, it is determined that the image frame to be rendered does not change compared with the adjacent previous image frame.

In yet another optional implementation, if the triangulation state only includes the left/right state of the ear-tip vertex, it is determined whether the left/right state of the ear-tip vertex of the target graphic object of the image frame to be rendered changes compared with the left/right state of the ear-tip vertex of the target graphic object on the adjacent previous image frame based on a cross product of a precursor vector and a successor vector of the ear-tip vertex, thereby determining whether the image frame to be rendered changes compared with the adjacent previous image frame.

If the left/right state of the ear-tip vertex of the target graphic object of the image frame to be rendered changes compared with the left/right state of the ear-tip vertex of the target graphic object of the adjacent previous image frame, it indicates that the image frame to be rendered changes compared with the adjacent previous image frame; and if the left/right state of the ear-tip vertex of the target graphic object of the image frame to be rendered does not change compared with the left/right state of the ear-tip vertex of the target graphic object on the adjacent previous image frame, it indicates that the image frame to be rendered does not change compared with the adjacent previous image frame.

Specifically, based on triangulation data of the target graphic object on the adjacent previous image frame of the image frame to be rendered, the ear-tip vertex of the target graphic object of the image frame to be rendered is determined, a cross product of the precursor vector and the successor vector of the ear-tip vertex is calculated, and based on a comparison result of the cross product corresponding to the ear-tip vertex and a cross product corresponding to a corresponding ear-tip vertex on the adjacent previous image frame, it is determined whether the image frame to be rendered changes compared with the adjacent previous image frame.

The triangulation refers to segmenting a graphic object into a plurality of triangles, and it should be noted that the triangulation method is not limited in any way in the present disclosure.

The ear-tip vertex refers to a vertex corresponding to a convex corner in the target graphic object of the image frame to be rendered, and a triangle formed by the convex corner does not contain other vertexes corresponding to the convex corner.

The precursor vector and the successor vector refer to a time sequence of vector drawing, a vector first drawn is called the precursor vector, and a vector later drawn is called the successor vector; and, referring to FIG. 4, which is a schematic diagram of a polygon provided by an embodiment of the present disclosure, as shown in FIG. 4, it is assumed that the ear-tip vertex is vertex B2, then corresponding precursor vector is \vec{A2B2}, and corresponding successor vector is \vec{B2W2}.

The left/right state of the ear-tip vertex refers to a left/right state of the successor vector of the ear-tip vertex relative to the precursor vector, i.e. whether the successor vector of the ear-tip vertex is on a left or right side of the precursor vector; and, continuing with reference to FIG. 4, it is assumed that the ear-tip vertex is vertex W2, corresponding precursor vector is \vec{B2W2}, and corresponding successor vector is \vec{W2Z2}, and it can be seen from FIG. 4 that the successor vector \vec{W2Z2} is on the right side of the precursor vector \vec{B2W2}, so the ear-tip vertex state of the vertex W2 is on the right side, and the corner corresponding thereto is a concave corner.

In the embodiment of the present disclosure, based on the triangulation data of the target graphic object on the adjacent previous image frame of the image frame to be rendered, an ear-tip vertex of the target graphic object of the image frame to be rendered is determined; a cross product of a precursor vector and a successor vector of the ear-tip vertex is calculated, if a cross product of the precursor vector and the successor vector of any one ear-tip vertex of the target graphic object of the image frame to be rendered is greater than 0 (or less than 0), and a cross product of the precursor vector and the successor vector of a corresponding ear-tip vertex of the target graphic object on the adjacent previous image frame of the image frame to be rendered is less than 0 (or greater than 0), it is determined that the left/right state of the ear-tip vertex changes, thereby determining that the image frame to be rendered changes compared with the adjacent previous image frame; and if the cross product of the precursor vector and the successor vector of each ear-tip vertex of the target graphic object of the image frame to be rendered and the cross product of the precursor vector and the successor vector of the corresponding ear-tip vertex of the target graphic object on the adjacent previous image frame are both greater than 0 or both less than 0, it is determined that the left/right state of the ear-tip vertex does not change, thereby determining that the image frame to be rendered does not change compared with the adjacent previous image frame. More specifically, taking FIG. 4 as an example, if the cross product of the precursor vector and the successor vector of the ear-tip vertex W2 of the target graphic object of the image frame to be rendered is greater than 0 (or less than 0), and the cross product of the precursor vector and the successor vector of the ear-tip vertex W2 of the target graphic object on the adjacent previous image frame of the image frame to be rendered is less than 0 (or greater than 0), it is determined that the left/right state of this ear-tip vertex W2 changes, thereby determining that the image frame to be rendered changes compared with the adjacent previous image frame. It should be appreciated that the image frame to be rendered is determined to change compared with the adjacent previous image frame, if a positive/negative state of the cross product of the precursor vector and successor vector of each of two or more ear-tip vertexes of the target graphic object of the image frame to be rendered changes compared with a positive/negative state of the cross product of the precursor vector and successor vector of the corresponding ear-tip vertex of the target graphic object on the adjacent previous image frame of the image frame to be rendered. For example, if the positive/negative state of the cross product of the precursor vector and the successor vector of the ear-tip vertex C of the target graphic object of the image frame to be rendered changes compared with the positive/negative state of the cross product of the precursor vector and the successor vector of the ear-tip vertex C of the target graphic object on the adjacent previous image frame of the image frame to be rendered, and the positive/negative state of the cross product of the precursor vector and the successor vector of the ear-tip vertex D of the target graphic object of the image frame to be rendered changes compared with the positive/negative state of the cross product of the precursor vector and the successor vector of the ear-tip vertex D of the target graphic object on the adjacent previous image frame of the image frame to be rendered, it is determined that the image frame to be rendered changes compared with the adjacent previous image frame.

It should be noted that, the present disclosure does not set any limit to the method of determining the left/right state of the ear-tip vertex.

It should be noted that, by combining the above two implementations, i.e., determining whether the triangulation state of the target graphic object of the image frame to be rendered changes compared with the triangulation state of the target graphic object of the adjacent previous image frame based on the number of vertexes and the left/right state of the ear-tip vertex of the target graphic object, the determination is more accurate, for which reference is specifically made to S102, and is not repeated here.
S103: in response to determining that the image frame to be rendered does not change compared with the adjacent previous image frame with respect to the triangulation state of the target graphic object, rendering the target graphic object on the image frame to be rendered based on triangulation data of a graphic object corresponding to the target graphic object on the adjacent previous image frame.

The data obtained after performing triangulation processing on any graphic object on any image frame is triangulation data of the graphic object.

In the embodiment of the present disclosure, if the number of vertexes and the left/right state of the ear-tip vertex of the target graphic object of the image frame to be rendered do not change, the target graphic object of the image frame to be rendered does not need to be triangulated again, and the target graphic object on the image frame to be rendered may be rendered by directly utilizing the triangulation data of the graphic object corresponding to the target graphic object on the adjacent previous image frame, vertex coordinate data of the target graphic object, and the like, thus repeated triangulation on the target graphic object is avoided, and the rendering performance is improved.

Referring to FIG. 5, which is a schematic diagram of another graphic object provided by an embodiment of the present disclosure, it is assumed that the target graphic object is a rectangle W2B2A2Z2 as shown in FIG. 5 and its adjacent previous image frame is a rectangle W1B1A1Z1 as shown in FIG. 3, it is determined that neither the number of vertexes nor the left/right state of the ear-tip vertex of the rectangle W2B2A2Z2 changes, then the rectangle W2B2A2Z2 may be rendered based on the triangulation data of the rectangle W1B1A1Z1 and the vertex coordinate data of the rectangle W2B2A2Z2.

In the animation rendering method provided by the embodiment of the present disclosure, it firstly determines a target graphic object on an image frame to be rendered in a target graphic animation and a graphic drawing mode of the target graphic object; in response to determining that the graphic drawing mode of the target graphic object is a fill drawing mode, it determines whether the image frame to be rendered changes compared with an adjacent previous image frame with respect to a triangulation state of the target graphic object, wherein the adjacent previous image frame is a previous frame adjacent to the image frame to be rendered in the target graphic animation; then, in response to determining that the image frame to be rendered does not change compared with the adjacent previous image frame with respect to the triangulation state of the target graphic object, it renders the target graphic object on the image frame to be rendered based on triangulation data of a graphic object corresponding to the target graphic object on the adjacent previous image frame.

As can be seen, in the embodiment of the present disclosure, by comparing the triangulation state of the target graphic object of the image frame to be rendered with that of the adjacent previous image frame, the target graphic object is rendered based on the triangulation data of the target graphic object in the adjacent previous image frame, thus repeated triangulation on the target graphic object is avoided, and the rendering performance is improved.

In some embodiments of the present disclosure, in response to determining that the graphic drawing mode of the target graphic object is a stroke drawing mode, triangulation processing is performed on the target graphic object based on the triangulation data of the adjacent previous image frame of the image frame to be rendered, to obtain triangulation data corresponding to the target graphic object, and then the target graphic object on the image frame to be rendered is rendered based on the triangulation data of the target graphic object.

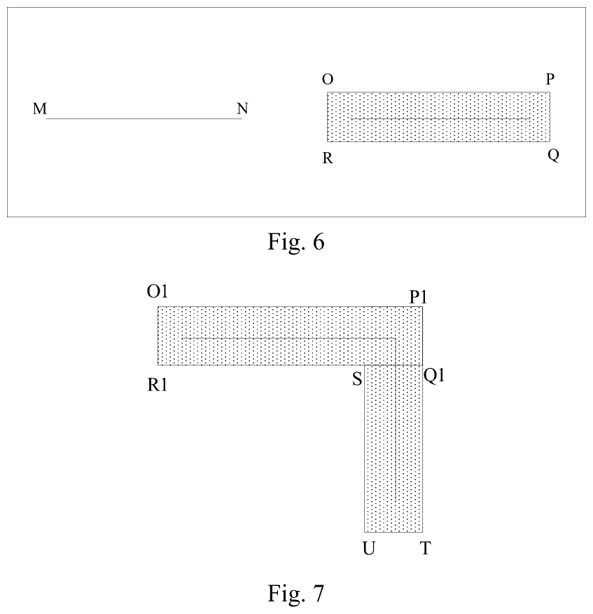

The stroke drawing mode is to fill an outline of a graphic object; and referring to FIG. 6, which is a schematic diagram of stroke drawing provided by an embodiment of the present disclosure, as shown in FIG. 6, a rectangle OPQR is stroke drawing on a line segment MN.

In the embodiment of the present disclosure, in response to determining that the graphic drawing mode of the target graphic object is a stroke drawing mode, the triangulation data of the target graphic object of the adjacent previous image frame is firstly obtained, then such triangulation data is reused for corresponding triangular parts in the target graphic object, then the triangulation processing is performed on the triangular parts in the target graphic object different from the adjacent previous image frame, and after the resultant triangulation data is accumulated with the triangulation data of the adjacent previous image frame, the triangulation data corresponding to the target graphic object is obtained, and the target graphic object on the image frame to be rendered is rendered based on the triangulation data of the target graphic object.

Specifically, the triangulation data corresponding to the target graphic object is as follows:
In an optional implementation, firstly, repeated drawing data of the drawing data of the target graphic object as compared with that of the adjacent previous image frame is determined, then triangulation processing is performed on a graphic part corresponding to the drawing data except the repeated drawing data in the drawing data of the target graphic object to obtain newly added triangulation data, and the triangulation data corresponding to the repeated drawing data and the newly added triangulation data are determined as the triangulation data corresponding to the target graphic object on the graphic frame to be rendered.

As shown in FIG. 6, the line segment MN and its corresponding stroked rectangle OPQR are displayed; and, assuming that a stroke width is 10 pixels, four vertex coordinates of the rectangle OPQR can be obtained from drawing data of the line segment MN and the stroke width, and then 2 triangles, i.e., a triangle OPQ and a triangle OQR, are obtained by triangulation.

Assuming that the target graphic object is a graphic shown in FIG. 7, referring to FIG. 7, which is a schematic diagram of another stroke drawing provided by an embodiment of the present disclosure, as shown in FIG. 7, a rectangle SQTU is newly added on the basis of FIG. 6; since the stroke data is one-dimensional data and the data can be accumulated, the triangulation data of FIG. 7 can be split into triangulation data of a rectangle O1P1Q1R1 (i.e., triangulation data corresponding to the repeated drawing data) and triangulation data of the rectangle SQTU (i.e., the newly added triangulation data), so that only the rectangle SQTU needs to be triangulated, and thus reuse of the repeated drawing data is realized and the rendering performance is improved.

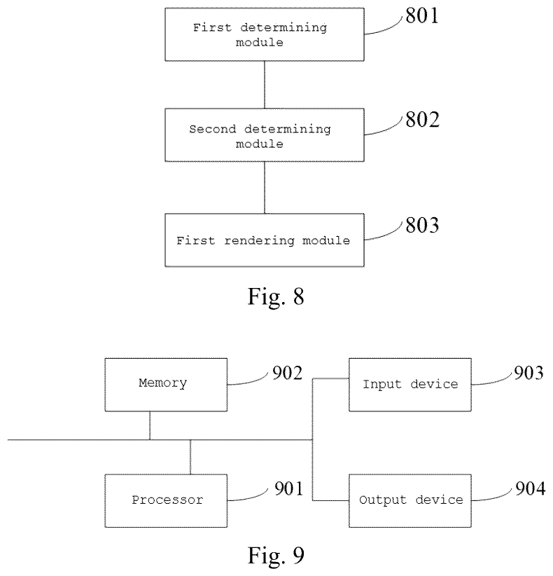

Based on the above method embodiments, the present disclosure further provides an animation rendering apparatus; referring to FIG. 8, which is a schematic structural diagram of an animation rendering apparatus provided by an embodiment of the present disclosure, the apparatus comprises:
a first determining module 801, configured to determine a target graphic object on an image frame to be rendered in a target graphic animation and a graphic drawing mode of the target graphic object;
a second determining module 802, configured to, in response to determining that the graphic drawing mode of the target graphic object is a fill drawing mode, determine whether the image frame to be rendered changes compared with an adjacent previous image frame with respect to a triangulation state of the target graphic object; wherein the adjacent previous image frame is a previous frame adjacent to the image frame to be rendered in the target graphic animation;
a first rendering module 803, configured to, in response to determining that the image frame to be rendered does not change compared with the adjacent previous image frame with respect to the triangulation state of the target graphic object, render the target graphic object on the image frame to be rendered based on triangulation data of a graphic object corresponding to the target graphic object on the adjacent previous image frame.

In an optional implementation, the second determining module comprises:
a first determination sub-module, configured to determine whether the image frame to be rendered changes compared with the adjacent previous image frame with respect to a number of vertexes of the target graphic object; and
a second determination sub-module, configured to determine whether the image frame to be rendered changes compared with the adjacent previous image frame with respect to the left/right state of the ear-tip vertex of the target graphic object.

In an optional implementation, the second determination sub-module is specifically configured to:
in response to determining that the image frame to be rendered does not change compared with the adjacent previous image frame with respect to the number of vertexes of the target graphic object, perform the step of determining whether the image frame to be rendered changes compared with the adjacent previous image frame with respect to a left/right state of an ear-tip vertex of the target graphic object.

In an optional implementation, the first determination sub-module comprises:
a third determination sub-module, configured to determine a drawing command for the target graphic object on the image frame to be rendered and a drawing command on the adjacent previous image frame as a first drawing command and a second drawing command, respectively;
an extraction sub-module, configured to extract a feature of the first drawing command and a feature of the second drawing command, respectively, according to a preset rule; and
a fourth determination sub-module, configured to determine whether the image frame to be rendered changes compared with the adjacent previous image frame based on a comparison result of the feature of the first drawing command and the feature of the second drawing command.

In an optional implementation, the second determination sub-module comprises:
a fifth determination sub-module, configured to determine the ear-tip vertex of the target graphic object based on the triangulation data of the adjacent previous image frame;
a calculation sub-module, configured to calculate a cross product of the precursor vector and the successor vector of the ear-tip vertex;
a sixth determination sub-module, configured to determine whether the image frame to be rendered changes compared with the adjacent previous image frame based on a comparison result of the cross product corresponding to the ear-tip vertex and a cross product corresponding to a corresponding ear-tip vertex of the adjacent previous image frame.

In an optional implementation, the apparatus further comprises:
a processing module, configured to, in response to determining that the graphic drawing mode of the target graphic object is a stroke drawing mode, perform triangulation processing on the target graphic object based on the triangulation data of the adjacent previous image frame of the image frame to be rendered, to obtain triangulation data corresponding to the target graphic object; and
a second rendering module, configured to render the target graphic object on the image frame to be rendered based on the triangulation data of the target graphic object.

In an optional implementation, the processing module comprises:
a seventh determination sub-module, configured to determine repeated drawing data of drawing data of the target graphic object as compared with the adjacent previous image frame;
a processing sub-module, configured to triangulation processing on a graphic part corresponding to drawing data except the repeated drawing data in the drawing data of the target graphic object, to obtain newly added triangulation data; and
an eighth determination sub-module, configured to determine the triangulation data corresponding to the repeated drawing data and the newly added triangulation data as the triangulation data corresponding to the target graphic object on the image frame to be rendered.

In the animation rendering apparatus provided by the embodiment of the present disclosure, it firstly determines a target graphic object on an image frame to be rendered in a target graphic animation and a graphic drawing mode of the target graphic object; in response to determining that the graphic drawing mode of the target graphic object is a fill drawing mode, it determines whether the image frame to be rendered changes compared with an adjacent previous image frame with respect to a triangulation state of the target graphic object; wherein the adjacent previous image frame is a previous frame adjacent to the image frame to be rendered in the target graphic animation; then, in response to determining that the image frame to be rendered does not change compared with the adjacent previous image frame with respect to the triangulation state of the target graphic object, it renders the target graphic object on the image frame to be rendered based on triangulation data of a graphic object corresponding to the target graphic object on the adjacent previous image frame.

As can be seen, in the embodiment of the present disclosure, by comparing the triangulation state of the target graphic object of the image frame to be rendered with that of the adjacent previous image frame, the target graphic object is rendered based on the triangulation data of the target graphic object in the adjacent previous image frame, thus repeated triangulation on the target graphic object is avoided, and the rendering performance is improved.

In addition to the above method and apparatus, an embodiment of the present disclosure further provides a computer-readable storage medium having instructions stored thereon, which, when executed on a terminal device, cause the terminal device to implement the animation rendering methods provided by the embodiments of the present disclosure.

An embodiment of the present disclosure further provides a computer program product comprising a computer program/instructions which, when executed by a processor, implement the animation rendering methods provided by the embodiments of the present disclosure.

An embodiment of the present disclosure further provides a computer program which, when executed by a processor, causes the processor to implement the animation rendering methods provided by the embodiments of the present disclosure.

In addition, an embodiment of the present disclosure further provides an animation rendering device, as shown in FIG. 9, which may comprise: a processor 901, a memory 902, an input device 903, and an output device 904. The number of processor 901 in the animation rendering device may be one or more, and one processor is taken as an example in FIG. 9. In some embodiments of the present disclosure, the processor 901, the memory 902, the input device 903 and the output device 904 may be connected by a bus or via another manner, wherein the connection by bus is exemplified in FIG. 9.

The memory 902 may be configured to store software programs and modules, and the processor 901 performs various functional applications and data processing of the animation rendering device by executing the software programs and modules stored in the memory 902. The memory 902 may mainly include a program storage area and a data storage area, wherein the program storage area may store an operating system, an application required for at least one function, and the like. Further, the memory 902 may include high speed random access memory, and may also include a non-volatile memory, such as at least one magnetic disk storage device, flash memory device, or other volatile solid state storage devices. The input device 903 may be configured to receive input numeric or character information and generate signal inputs related to user settings and function controls of the animation rendering device.

Specifically, in this embodiment, the processor 901 loads an executable file corresponding to a process of one or more applications into the memory 902 according to the following instructions, and the processor 901 runs the applications stored in the memory 902, thereby implementing various functions of the animation rendering device.

It is noted that, relational terms such as “first” and “second,” and the like herein, are used solely to distinguish one entity or action from another entity or action without necessarily requiring or implying any actual such relationship or order between such entities or actions. Also, the terms “comprise,” “include” or any other variation thereof, are intended to cover a non-exclusive inclusion, such that a process, method, article, or apparatus that comprises a list of elements does not include only those elements but may include other elements not expressly listed or inherent to such process, method, article, or apparatus. Without further limitation, an element defined by the phrase “comprising an . . . ” does not exclude the presence of other identical elements in the process, method, article, or apparatus that comprises the element.

The above only describes particular embodiments of the present disclosure, so as to enable those skilled in the art to understand or implement the present disclosure. Various modifications to these embodiments will be apparent to those skilled in the art, and the generic principles defined herein may be applied to other embodiments without departing from the spirit or scope of the present disclosure. Thus, the present disclosure is not intended to be limited to the embodiments shown herein but is to be accorded with the widest scope consistent with the principles and novel features disclosed herein.

1. An animation rendering method, comprising:
determining a target graphic object on an image frame to be rendered in a target graphic animation and a graphic drawing mode of the target graphic object;
in response to determining that the graphic drawing mode of the target graphic object is a fill drawing mode, determining whether the image frame to be rendered changes compared with an adjacent previous image frame with respect to a triangulation state of the target graphic object; wherein the adjacent previous image frame is a previous frame adjacent to the image frame to be rendered in the target graphic animation; and
in response to determining that the image frame to be rendered does not change compared with the adjacent previous image frame with respect to the triangulation state of the target graphic object, rendering the target graphic object on the image frame to be rendered based on triangulation data of a graphic object corresponding to the target graphic object on the adjacent previous image frame.

2. The method according to claim 1, wherein the determining whether the image frame to be rendered changes compared with an adjacent previous image frame with respect to a triangulation state of the target graphic object, comprises:
determining whether the image frame to be rendered changes compared with the adjacent previous image frame with respect to a number of vertexes of the target graphic object; and/or
determining whether the image frame to be rendered changes compared with the adjacent previous image frame with respect to a left/right state of an ear-tip vertex of the target graphic object, wherein the left/right state of the ear-tip vertex indicates whether a successor vector of the ear-tip vertex is on a left or right side of a precursor vector of the ear-tip vertex.

3. The method according to claim 2, wherein the determining whether the image frame to be rendered changes compared with the adjacent previous image frame with respect to a left/right state of an ear-tip vertex of the target graphic object, comprises:
in response to determining that the image frame to be rendered does not change compared with the adjacent previous image frame with respect to the number of vertexes of the target graphic object, performing the step of determining whether the image frame to be rendered changes compared with the adjacent previous image frame with respect to a left/right state of an ear-tip vertex of the target graphic object.

4. The method according to claim 2, wherein the determining whether the image frame to be rendered changes compared with the adjacent previous image frame with respect to a number of vertexes of the target graphic object, comprises:
determining a drawing command for the target graphic object on the image frame to be rendered and a drawing command for the corresponding graphic object on the adjacent previous image frame as a first drawing command and a second drawing command, respectively;
extracting a feature of the first drawing command and a feature of the second drawing command, respectively, according to a preset rule; and
determining whether the image frame to be rendered changes compared with the adjacent previous image frame based on a comparison result of the feature of the first drawing command and the feature of the second drawing command.

5. The method according to claim 2, wherein the determining whether the image frame to be rendered changes compared with the adjacent previous image frame with respect to a left/right state of an ear-tip vertex of the target graphic object, comprises:
determining the ear-tip vertex of the target graphic object based on the triangulation data of the adjacent previous image frame;
calculating a cross product of the precursor vector and the successor vector of the ear-tip vertex; and
determining whether the image frame to be rendered changes compared with the adjacent previous image frame based on a comparison result of the cross product corresponding to the ear-tip vertex and a cross product corresponding to a corresponding ear-tip vertex of the adjacent previous image frame.

6. The method according to claim 1, further comprising:
in response to determining that the graphic drawing mode of the target graphic object is a stroke drawing mode, performing triangulation processing on the target graphic object based on the triangulation data of the adjacent previous image frame of the image frame to be rendered, to obtain triangulation data corresponding to the target graphic object; and
rendering the target graphic object on the image frame to be rendered based on the triangulation data of the target graphic object.

7. The method according to claim 6, wherein the performing triangulation processing on the target graphic object based on the triangulation data of the adjacent previous image frame of the image frame to be rendered, to obtain triangulation data corresponding to the target graphic object, comprises:
determining repeated drawing data of drawing data of the target graphic object as compared with the adjacent previous image frame;
performing triangulation processing on a graphic part corresponding to drawing data except the repeated drawing data in the drawing data of the target graphic object, to obtain newly added triangulation data; and
determining the triangulation data corresponding to the repeated drawing data and the newly added triangulation data as the triangulation data corresponding to the target graphic object on the image frame to be rendered.

8. (canceled)

9. A non-transitory computer-readable storage medium having stored thereon instructions which, when executed on a terminal device, cause the terminal device to implement the following animation rendering operations:
determining a target graphic object on an image frame to be rendered in a target graphic animation and a graphic drawing mode of the target graphic object;
in response to determining that the graphic drawing mode of the target graphic object is a fill drawing mode, determining whether the image frame to be rendered changes compared with an adjacent previous image frame with respect to a triangulation state of the target graphic object; wherein the adjacent previous image frame is a previous frame adjacent to the image frame to be rendered in the target graphic animation; and
in response to determining that the image frame to be rendered does not change compared with the adjacent previous image frame with respect to the triangulation state of the target graphic object, rendering the target graphic object on the image frame to be rendered based on triangulation data of a graphic object corresponding to the target graphic object on the adjacent previous image frame.

10. An animation rendering device comprising: a memory, a processor, and a computer program stored on the memory and executable on the processor, wherein the processor, when executing the computer program, implements the following animation rendering operations:
determining a target graphic object on an image frame to be rendered in a target graphic animation and a graphic drawing mode of the target graphic object;
in response to determining that the graphic drawing mode of the target graphic object is a fill drawing mode, determining whether the image frame to be rendered changes compared with an adjacent previous image frame with respect to a triangulation state of the target graphic object; wherein the adjacent previous image frame is a previous frame adjacent to the image frame to be rendered in the target graphic animation; and
in response to determining that the image frame to be rendered does not change compared with the adjacent previous image frame with respect to the triangulation state of the target graphic object, rendering the target graphic object on the image frame to be rendered based on triangulation data of a graphic object corresponding to the target graphic object on the adjacent previous image frame.

11. (canceled)

12. (canceled)

13. The storage medium according to claim 9, wherein the determining whether the image frame to be rendered changes compared with an adjacent previous image frame with respect to a triangulation state of the target graphic object, comprises:
determining whether the image frame to be rendered changes compared with the adjacent previous image frame with respect to a number of vertexes of the target graphic object; and/or
determining whether the image frame to be rendered changes compared with the adjacent previous image frame with respect to a left/right state of an ear-tip vertex of the target graphic object, wherein the left/right state of the ear-tip vertex indicates whether a successor vector of the ear-tip vertex is on a left or right side of a precursor vector of the ear-tip vertex.

14. The storage medium according to claim 13, wherein the determining whether the image frame to be rendered changes compared with the adjacent previous image frame with respect to a left/right state of an ear-tip vertex of the target graphic object, comprises:
in response to determining that the image frame to be rendered does not change compared with the adjacent previous image frame with respect to the number of vertexes of the target graphic object, performing the step of determining whether the image frame to be rendered changes compared with the adjacent previous image frame with respect to a left/right state of an ear-tip vertex of the target graphic object.

15. The storage medium according to claim 13, wherein the determining whether the image frame to be rendered changes compared with the adjacent previous image frame with respect to a number of vertexes of the target graphic object, comprises:
determining a drawing command for the target graphic object on the image frame to be rendered and a drawing command for the corresponding graphic object on the adjacent previous image frame as a first drawing command and a second drawing command, respectively;
extracting a feature of the first drawing command and a feature of the second drawing command, respectively, according to a preset rule; and
determining whether the image frame to be rendered changes compared with the adjacent previous image frame based on a comparison result of the feature of the first drawing command and the feature of the second drawing command.

16. The storage medium according to claim 13, wherein the determining whether the image frame to be rendered changes compared with the adjacent previous image frame with respect to a left/right state of an ear-tip vertex of the target graphic object, comprises:
determining the ear-tip vertex of the target graphic object based on the triangulation data of the adjacent previous image frame;
calculating a cross product of the precursor vector and the successor vector of the ear-tip vertex; and
determining whether the image frame to be rendered changes compared with the adjacent previous image frame based on a comparison result of the cross product corresponding to the ear-tip vertex and a cross product corresponding to a corresponding ear-tip vertex of the adjacent previous image frame.

17. The storage medium according to claim 9, wherein the instructions, when executed on the terminal device, cause the terminal device to further implement the following operations:
in response to determining that the graphic drawing mode of the target graphic object is a stroke drawing mode, performing triangulation processing on the target graphic object based on the triangulation data of the adjacent previous image frame of the image frame to be rendered, to obtain triangulation data corresponding to the target graphic object; and
rendering the target graphic object on the image frame to be rendered based on the triangulation data of the target graphic object.

18. The storage medium according to claim 17, wherein the performing triangulation processing on the target graphic object based on the triangulation data of the adjacent previous image frame of the image frame to be rendered, to obtain triangulation data corresponding to the target graphic object, comprises:
determining repeated drawing data of drawing data of the target graphic object as compared with the adjacent previous image frame;
performing triangulation processing on a graphic part corresponding to drawing data except the repeated drawing data in the drawing data of the target graphic object, to obtain newly added triangulation data; and
determining the triangulation data corresponding to the repeated drawing data and the newly added triangulation data as the triangulation data corresponding to the target graphic object on the image frame to be rendered.

19. The device according to claim 10, wherein the determining whether the image frame to be rendered changes compared with an adjacent previous image frame with respect to a triangulation state of the target graphic object, comprises:
determining whether the image frame to be rendered changes compared with the adjacent previous image frame with respect to a number of vertexes of the target graphic object; and/or
determining whether the image frame to be rendered changes compared with the adjacent previous image frame with respect to a left/right state of an ear-tip vertex of the target graphic object, wherein the left/right state of the ear-tip vertex indicates whether a successor vector of the ear-tip vertex is on a left or right side of a precursor vector of the ear-tip vertex.

20. The device according to claim 19, wherein the determining whether the image frame to be rendered changes compared with the adjacent previous image frame with respect to a left/right state of an ear-tip vertex of the target graphic object, comprises:
in response to determining that the image frame to be rendered does not change compared with the adjacent previous image frame with respect to the number of vertexes of the target graphic object, performing the step of determining whether the image frame to be rendered changes compared with the adjacent previous image frame with respect to a left/right state of an ear-tip vertex of the target graphic object.

21. The device according to claim 19, wherein the determining whether the image frame to be rendered changes compared with the adjacent previous image frame with respect to a number of vertexes of the target graphic object, comprises:
determining a drawing command for the target graphic object on the image frame to be rendered and a drawing command for the corresponding graphic object on the adjacent previous image frame as a first drawing command and a second drawing command, respectively;
extracting a feature of the first drawing command and a feature of the second drawing command, respectively, according to a preset rule; and
determining whether the image frame to be rendered changes compared with the adjacent previous image frame based on a comparison result of the feature of the first drawing command and the feature of the second drawing command.

22. The device according to claim 19, wherein the determining whether the image frame to be rendered changes compared with the adjacent previous image frame with respect to a left/right state of an ear-tip vertex of the target graphic object, comprises:
determining the ear-tip vertex of the target graphic object based on the triangulation data of the adjacent previous image frame;
calculating a cross product of the precursor vector and the successor vector of the ear-tip vertex; and
determining whether the image frame to be rendered changes compared with the adjacent previous image frame based on a comparison result of the cross product corresponding to the ear-tip vertex and a cross product corresponding to a corresponding ear-tip vertex of the adjacent previous image frame.

23. The device according to claim 10, wherein the processor, when executing the computer program, further implements the following operations:
in response to determining that the graphic drawing mode of the target graphic object is a stroke drawing mode, performing triangulation processing on the target graphic object based on the triangulation data of the adjacent previous image frame of the image frame to be rendered, to obtain triangulation data corresponding to the target graphic object; and
rendering the target graphic object on the image frame to be rendered based on the triangulation data of the target graphic object.
